(19) United States
(12) Patent Application Publication
(10) Pub. No.: US 2010/0089097 A1
(43) Pub. Date: Apr. 15, 2010

(54) METHOD FOR THE PRODUCTION OF PHARMACEUTICAL PACKAGING

(76) Inventors: Heike Brack, Budenheim (DE); Uwe Rothhaar, Birkenheide (DE); Stephan Tratzky, Neustadt an der Waldnaab (DE); Juergen Thuerk, St. Gallen (CH)

Correspondence Address: HARNESS, DICKEY & PIERCE, P.L.C., P.O. BOX 828, BLOOMFIELD HILLS, MI, 48303, US

(21) Appl. No.: 12/574,896

(22) Filed: Oct. 7, 2009

(30) Foreign Application Priority Data
Oct. 9, 2008 (DE) 10 2008 051 614.7

(51) Int. Cl. C03C 23/00; C03C 17/00; C03B 23/04; C03B 15/14

(52) U.S. Cl. 65/31; 65/60.1; 65/60.53; 65/108; 65/30.1

(57) ABSTRACT

The invention discloses a method for the production of packaging made from borosilicate glass for pharmaceutical products and medical products comprising the steps of: providing a glass tube made from a borosilicate base glass, generating a temporary interface layer on an inner surface of the glass tube, hot-forming the glass tube at a temperature above T_{g}, and cooling down the glass tube to room temperature.

### BACKGROUND OF THE INVENTION

The present invention relates to a method for the production of packaging made from glass for pharmaceutical products and medical products where a tube consisting of a base glass, such as borosilicate glass, is converted to a glass product by hot-forming.

Glass tubes have been known for many years as pharmaceutical packaging and packaging for medical products, such as syringes, ampoules, etc. For this purpose, thin glass tubes are initially drawn from the melt and are then, in an additional process, converted to the final product by hot-forming. Large-scale production technologies normally use borosilicate glasses, as these offer a relatively high chemical resistance. However, it has been found that the surface quality is not always sufficient to meet all demands.

While tubes made from quartz glass are not connected with that disadvantage and offer high chemical resistance, quartz glass can be produced and processed only with high input so that it does not lend itself for economical mass production.

In order to avoid the disadvantages connected with quartz glass one has tried to coat the inner surfaces of glass containers, formed as tubes from low-melting glass, with a silicon oxide layer or another oxide layer with the aim to obtain highly resistant inner surfaces (compare DE 198 01 861 A1).

The inner surface of the semi-finished glass tube is coated for this purpose with a layer of oxidic materials (SiO₂, Al₂O₃, TiO₂ or mixtures thereof) of a thickness adapted to the subsequent process conditions prevailing in the conversion of the formed glass body and the demands placed on the chemical resistance. Thereafter, the formed glass body is produced by converting the semi-finished glass tube with the coating on its inside. The coating on the inner surface may be produced from the liquid phase according to the sol-gel method or by separation from a solution supersaturated with an acidic coating material. Preferably, however, coating of the inner surface is effected by chemical separation of the oxidic coating material from its gas phase (CVD method).

While separation from the gas phase is a very complex and expensive process, coating of the inner surfaces by the sol-gel method not always resulted in satisfactory solutions offering satisfactory chemical resistance.

Further, it has been known in the art (DE 1 421 844) to apply a vaporization process using acid gasses (sulfur oxide or haloid acid gas) at raised temperatures in order to achieve alkali leaching of the surface of soda-aluminum-oxide silicate glasses and, thus, to improve the resistance and/or mechanical strength of the glass products.

In view of this, it is a first object of the invention to disclose a method for the production of packaging made from glass for pharmaceutical products and medical products.

It is a second object of the invention to disclose a method for the production of packaging made from glass which is suited for large-series production.

It is a third object of the invention to disclose a method for the production of packaging made from glass which makes the production of such packaging as simple and cost-effective as possible.

It is a forth object of the invention to disclose a method for the production of packaging made from glass which provides for a high surface quality.

### SUMMARY OF THE INVENTION

These and other objects of the invention are achieved by a method for the production of glass packaging for pharmaceutical products and medical products comprising the steps of:

(a) Providing a tube made from a base glass and provided with a temporary interface layer on its inner surface;

(b) hot-forming the tube at a temperature above the glass transformation temperature T_{g}; and

(c) cooling down the tube to room temperature.

The object of the invention is thus perfectly achieved.

It has been found, especially with borosilicate glasses, that borates vaporize during hot-forming of the tube and attack the inner surface of the tube, which leads to deterioration of the surface quality and increases the susceptibility to leaching.

By producing a temporary protective layer on the inner surface of glass tubes prior to the hot-forming process, that damaging attack by the materials vaporizing during the hot-forming process can be prevented. Another advantage of the temporary interface layer is seen in the fact that it avoids, or at least reduces, the adhering tendency of loose particles that may be encountered, for example, during isolation of the tubes.

Consequently, on the one hand borate-induced surface deficiencies such as corrosion cavities and superficial vitrification are reduced or even prevented, and on the other hand no detrimental modification of the zone near the surface (“altered layer”) is encountered.

As a result, one in particular achieves an improved morphological surface quality. And the alkali leaching values are improved as well.

According to a further embodiment of the invention the temporary protective layer may be removed later by a washing step, for example.

According to a further embodiment of the invention the temporary interface layer is generated in-situ by applying an acid gas or by applying a gas burner, such as a propane gas burner while producing the tube by means of drawing.

This leads to the advantage that the generation of the temporary protective layer can be combined with the tube generating process, so that almost no slow-down is expected during manufacturing.

Alternatively, the temporary interface layer can be generated after the tube generating process, preferably on tubes that have been isolated already.

Thereby the tube generation and the generation of the temporary interface layer can be decoupled from each other.

The temporary interface layer may later be removed, e.g. by washing off.

Since the removable temporary can be removed without any problem as part of the washing step anyway required for the packaging before the units are filled with pharmaceutical products and medical products, a very simple and low-cost production process is guaranteed, practically without any additional costs. This means that the invention simultaneously improves the quality of the inner glass surface and the resistance to leaching.

Preferably, the base glass is a borosilicate glass, and hot-forming preferably is carried out at a temperature of 1000° C. to 1300° C., preferably at 1100° C. to 1300° C.

As far as the temporary interface layer is produced by injecting a salt solution, herein the salts may be sprayed into the respective tube part before hot-forming.

The manner in which the temporary interface layer is produced is not of fundamental importance. The temporary interface layer, serving as a protective layer during the hot-forming process, blocks the attacks by boron-oxygen-containing particles on the glass surface. This guarantees in any case a reduction of the detrimental effect of evaporated glass components during the hot-forming process.

As the temporary interface layer as such is of a temporary nature only and can be removed for example by washing, it acts to protect the remaining surface layer of the product being produced.

According to a preferred embodiment of the invention, the temporary interface layer is removed by a washing step after hot-forming of the tube.

That washing step may be carried out with de-ionized water at a temperature above room temperature, preferably in the range of 50° C. to 70° C.

That feature provides the advantage that no additional washing step is required for removing the temporary interface layer since that washing step can be combined with the washing step anyway required before the products can be used as pharmaceutical packaging.

The method according to the invention preferably is used for the production of all products that are made from glass tubes, in particular for the production of vials, syringes, carpoules and ampoules or for the production of glass tubes per se.

It was found that a short time span is sufficient for generating the temporary interface layer, such as 600 seconds, preferably 60 seconds, or 30 seconds, or even 10 seconds at the most.

Surprisingly it was found that a protective effect is reached already with a temporary interface layer that doesn't exist as a complete layer, but exists only partially.

It is understood that the features of the invention mentioned above and those yet to be explained below can be used not only in the respective combination indicated, but also in other combinations or in isolation, without leaving the scope of the invention.

### BRIEF DESCRIPTION OF THE DRAWINGS

Further features and advantages of the invention will become apparent from the description that follows of certain preferred embodiments, with reference to the drawing. In the drawings:

FIG. 1 shows a diagrammatic representation of the attack by boron-oxygen-containing particles during the process of hot-forming a conventional pharmaceutical packaging from glass;

FIG. 2 shows a diagrammatic representation of the pharmaceutical packaging according to FIG. 1, after the hot-forming process;

FIG. 3 shows a diagrammatic representation of the pharmaceutical packaging according to the invention during the hot-forming process;

FIG. 4 shows a diagrammatic representation of the pharmaceutical packaging according to the invention after removal of the temporary interface layer;

FIG. 5 shows an SEM plot of an inner surface of a pharmaceutical packaging in the form of a glass tube after a gas treatment using SO₂;

FIG. 6 shows an SEM plot of the inner surface of a conventional pharmaceutical packaging without an temporary interface layer, with boron-induced corrosion effects;

FIG. 7 shows a comparison of the sodium leaching values of a conventional pharmaceutical packaging in the form of glass tubes made from borosilicate glass without a temporary interface layer (indicated by “Standard”) and of a pharmaceutical packaging according to the invention in the form of glass tubes (indicated by “Invention”), i.e. a pharmaceutical packaging where the inner surface of the tubes was subjected to an SO₂ gas treatment prior to the hot-forming process;

FIG. 8 shows an SEM plot of the inner surface of a pharmaceutical packaging according to the intention, produced by hot-forming from a pharmaceutical packaging on which a temporary interface layer had been applied before;

FIG. 9 shows an SEM plot of an inner surface of a pharmaceutical packaging according to the invention, after conditioning by means of a gas burner (before rinsing);

FIG. 10 shows an SEM plot of the inner surface of a conventional pharmaceutical packaging (before rinsing);

FIG. 11 shows a comparison of the sodium leaching values in mg/l of a conventional pharmaceutical packaging in the form of glass tubes made from borosilicate glass without a temporary interface layer (indicated by “Standard”) and of a pharmaceutical packaging according to the invention in the form of glass tubes (indicated by “Invention”), i.e. a packaging where the inner surfaces of the glass tubes were subjected to the action of a propane gas flame prior to the hot-forming process; and

FIG. 12 shows a SEM/EDX analysis (scanning electron microscope and energy-dispersive X-ray spectroscopy) of the temporary interface layer produced.

### DETAILED DESCRIPTION OF THE PREFERRED EMBODIMENTS

FIGS. 1 to 4 illustrate in diagrammatic form the difference between the conventional production of vials made from glass tubes and the production of vials according to the invention.

For comparison, FIG. 1 shows a diagrammatic cross-section of a surface detail of a glass tube 10 according to the prior art. The attack of borates on the glass wall 12 during the hot-forming process is indicated at 14.

According to FIG. 2, the hot-forming process yields a glass tube 10a with a glass wall 12 carrying on its inside a layer 16 that exhibits corrosion defects and surface deficiencies.

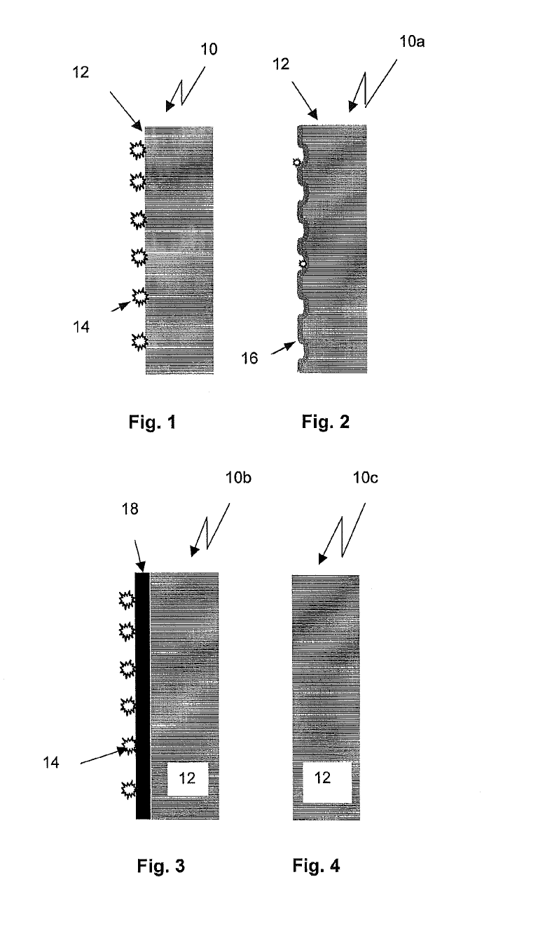

In contrast, a glass tube 10b according to the invention, illustrated in FIG. 3, has a glass wall 12 with a temporary interface layer 18 on the tube inside. During hot-forming, it is primarily that the temporary interface layer 18 which is attacked by borate 14. However, due to its structure that layer is largely inert to borate.

FIG. 4 shows a detail of the wall of the glass tube 10c after the temporary interface layer 18 has been washed off using de-ionized water at 60° C.

### Example 1

The inner surface of glass tubes made from borosilicate glass (type Fiolax®, produced and marketed by Schott AG, Mainz) was subjected to a gassing operation using a gas mixture composed of 50% SO₂ and 50% air, where the mixture had a water content of 40 g/m³. The SO₂ gas treatment was carried out for 600 seconds. The tube sections so treated were formed into vials of a desired dimension at a temperature of approximately 1200° C., using a forming machine. The inner surfaces, with and without SO₂ gas treatment, were examined by scanning electron microscopy (SEM). Following the forming process the glass tubes were rinsed for 10 minutes at 60° C. using de-ionized water. Finally, sodium leaching of the conventional glass tubes, and the glass tubes according to the invention was tested by autoclaving (60 minutes at 121° C. with de-ionized water).

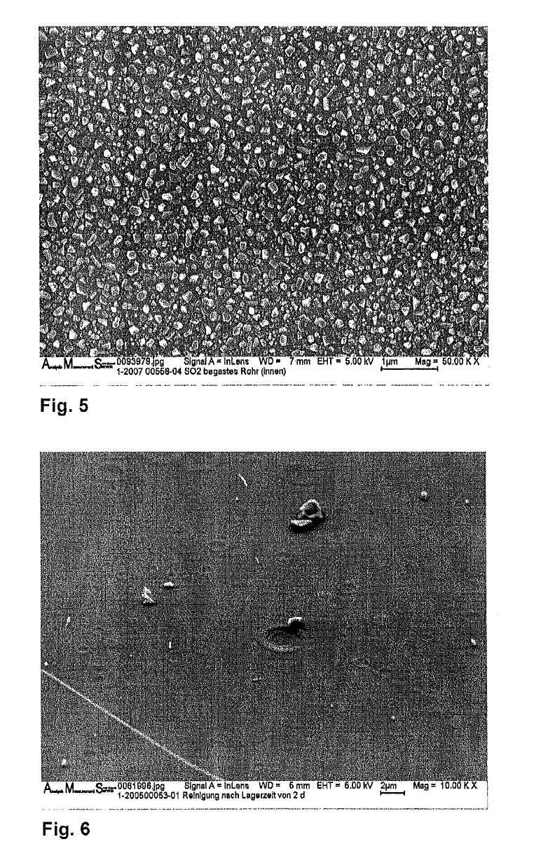

The “gas treated” tube surfaces show (before the forming operation) a dense coat of crystals, as can be seen in the SEM plot of FIG. 5. The crystals, having diameters of some 10 nm up to 100 nm predominantly consist of sodium, sulfur and oxygen (NaₓSO_{y}).

Surface defects of the kind typically produced in conventional glass tubes (compare FIG. 6) are observed on the glass tubes made from “gas-treated” tubes either not at all or to a much lesser degree (compare FIG. 8).

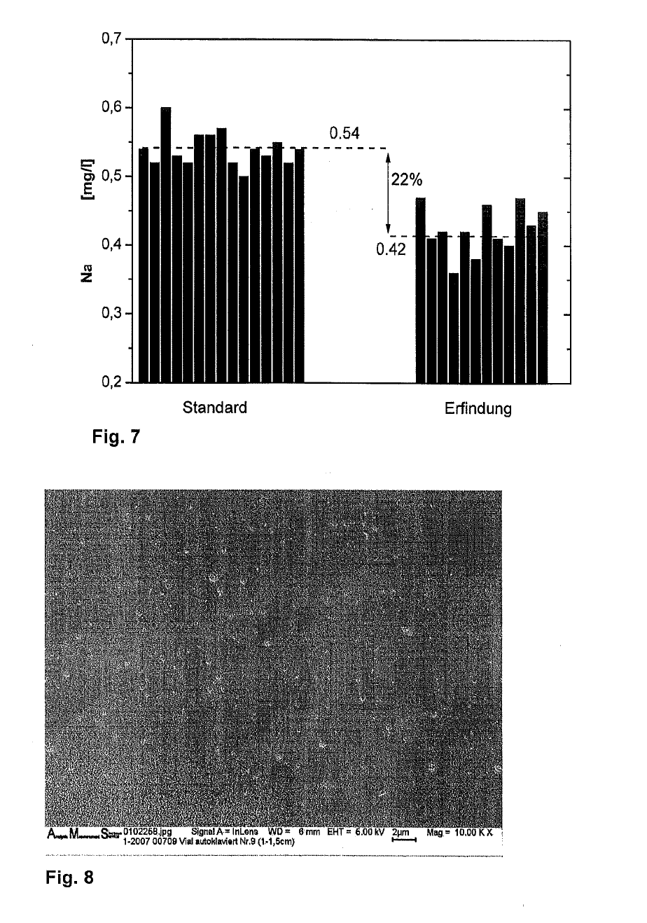

The leaching effect on glass tubes that had been provided with a temporary interface layer by SO₂ gassing was lower by approximately 22% in average than the leaching effect on conventional glass tubes (compare sodium leaching according to FIG. 7).

All glass tubes were formed on the same machine and in the same format.

### Example 2

The inner surface of glass tubes made from borosilicate glass (Type Fiolax®, produced and marketed by Applicant) was treated using a propane gas flame, either (a) stationarily for a defined time or (b) continuously at a constant speed. Thereafter, corresponding glass tubes were produced from the tube sections so conditioned using a hot-forming machine.

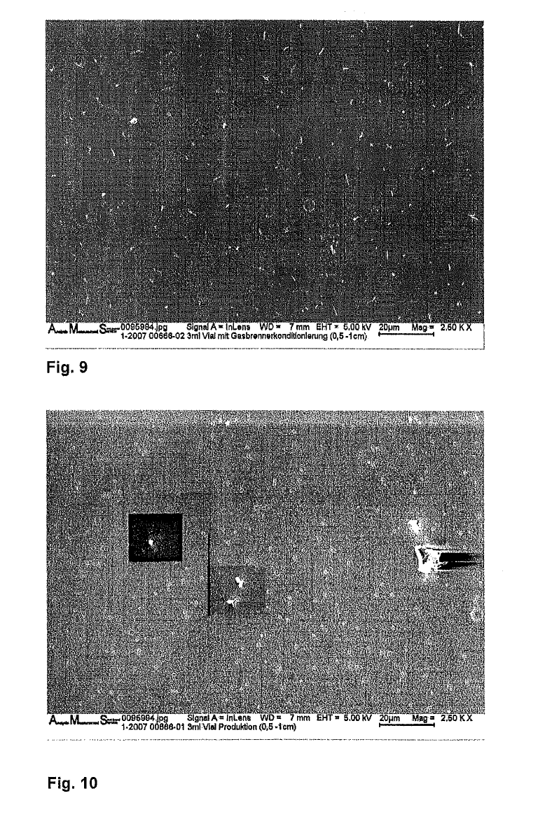

FIG. 9 shows an SEM plot of the inner surface of a glass tube after conditioning using a propane gas flame (before rinsing).

FIG. 10 shows, by way of comparison, an SEM plot of the inner surface of a conventional glass tube with coarse surface defects.

FIG. 11 shows the sodium leaching values after the autoclaving operating according to FIG. 1, comparing vials formed from conventional glass tubes (“Standard”) and vials produced in the way proposed by the invention, including conditioning using a propane gas flame prior to hot-forming (“Invention”).

The sodium leaching value is lower by approximately 20% in average for the glass tubes produced according to the invention.

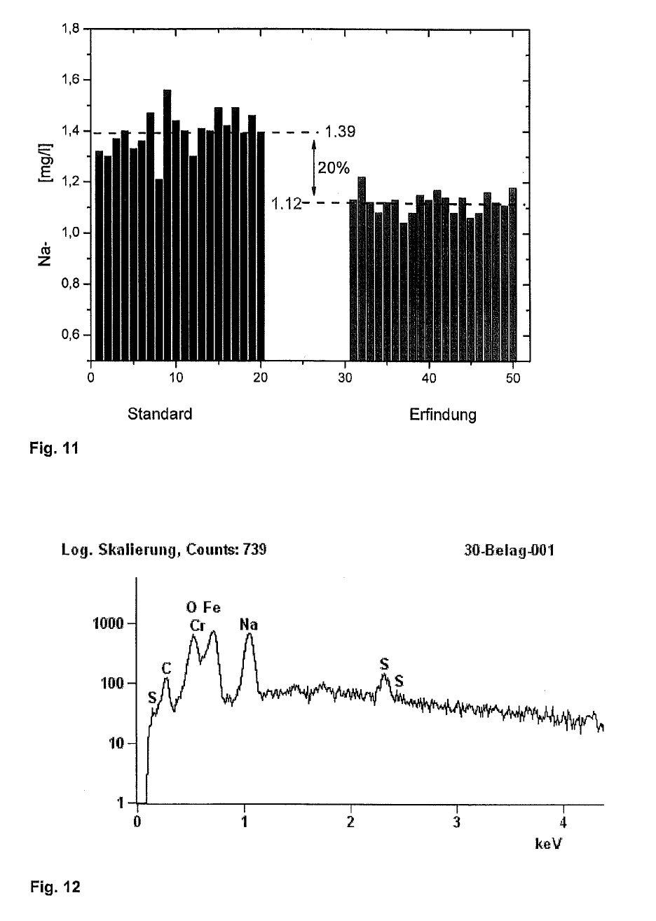

FIG. 12 shows an examination of the temporary interface layer after the flame treatment using the propane gas burner, obtained by scanning electron microscopy and energy-dispersive X-ray spectroscopy (SEM/EDX). The examination shows that the temporary interface layer produced contains the elements Na, S and O (Fe and Cr due to the carrier plate used in the analysis). The layer produced is a sodium sulfate layer (NaₓSO_{y}).

1. A method of producing packaging made from glass for pharmaceutical products and medical products comprising the steps of:
(a) generating a borosilicate glass tube by a glass drawing process, while simultaneously applying an acid gas or a flame treatment with a gas burner, thereby generating a glass tube provided with a temporary interface layer on its inner surface;
(b) hot-forming the glass tube at a temperature above the glass transformation temperature T_{g};
(c) cooling down the glass tube to room temperature; and
(d) removing said temporary interface layer by a washing step.

2. The method of claim 1, wherein said temporary interface layer is removed by a washing step using de-ionized water at a temperature in the range of 50° C. to 70° C.

3. The method of claim 2, wherein said hot-forming step is carried out at a temperature of 1100° C. to 1300° C.

4. The method of claim 3, wherein said temporary interface layer is produced by treating said gas tube with SO₂ gas.

5. A method of producing packaging made from glass for pharmaceutical products and medical products comprising the steps of:
(a) generating a borosilicate glass tube by a glass drawing process, while simultaneously applying an acid gas or a flame treatment with a gas burner, thereby generating a glass tube provided with a temporary interface layer on its inner surface;
(b) hot-forming the glass tube at a temperature above the glass transformation temperature T_{g}; and
(c) cooling down the glass tube to room temperature.

6. The method of claim 5, wherein said hot-forming step is carried out at a temperature of 1000° C. to 1300° C.

7. The method of claim 5, wherein said temporary interface layer is produced by treating said gas tube with SO₂ gas.

8. The method of claim 5, wherein said temporary interface layer is produced by treating said gas tube with SO₂ gas within a maximum time of 60 seconds.

9. The method of claim 8, wherein said temporary interface layer is removed by a washing step after hot-forming of the glass tube.

10. The method of claim 5, wherein said temporary interface layer is removed by a washing step using de-ionized water at a temperature in the range of 50° C. to 70° C.

11. A method of producing packaging made from glass for pharmaceutical products and medical products comprising the steps of:
(a) providing a tube made from a base glass and provided with a temporary interface layer on its inner surface;
(b) hot-forming the tube at a temperature above the glass transformation temperature T_{g}; and
(c) cooling down the glass tube to room temperature.

12. The method of claim 11, wherein said temporary interface layer is produced after manufacture of the glass tube.

13. The method of claim 12, wherein said temporary interface layer is produced after a glass tube has been isolated into individual glass tubes.

14. The method of claim 12, wherein said temporary interface layer is produced by a method selected from the group consisting of gassing the inner surface of the glass tube with acid gasses, flame treating using gas burners, reactive plasma processing, leaching process, and spraying a salt fluid onto said inner surface of said glass tube.

15. The method of claim 11, wherein a temporary interface layer is produced that comprises Glauber's salt crystals.

16. The method of claim 11, wherein said temporary interface layer is produced by treating said gas tube with SO₂ gas.

17. The method of claim 11, wherein said base glass used is a borosilicate glass.

18. The method of claim 11, wherein hot-forming is carried out at a temperature of 1000° C. to 1300° C.

19. The method of claim 11, wherein said temporary interface layer is removed by a washing step after hot-forming of said glass tube.

20. The method of claim 11, wherein said temporary interface layer is removed by a washing step using de-ionized water at a temperature of 50° C. to 70° C.
